(19) United States
(12) Patent Application Publication
(10) Pub. No.: US 2017/0128760 A1
(43) Pub. Date: May 11, 2017

(54) INSPECTION SYSTEM AND METHOD FOR HVAC UNITS

(71) Applicant: JOHN WILSON, WESTFIELD, MA (US)

(72) Inventor: JOHN WILSON, WESTFIELD, MA (US)

(73) Assignee: Mestek, Inc., Westfield, MA (US)

(21) Appl. No.: 15/343,298

(22) Filed: Nov. 4, 2016

Related U.S. Application Data
(60) Provisional application No. 62/251,861, filed on Nov. 6, 2015.

(51) Int. Cl. A62C 37/50; A62C 2/24

(52) U.S. Cl. CPC A62C 37/50; A62C 2/24

(57) ABSTRACT

An inspection system for an HVAC device includes an HVAC duct section, a damper positioned with the duct section, an actuator for selectively moving the damper to a closed position, and a verification camera for recording the position of the damper with a date stamp and a time stamp. The actuator is further configured to move the damper to its open position, and the verification camera is further configured to record the open position of the damper with a second date and time stamp.

### CROSS-REFERENCE TO RELATED APPLICATIONS

This application claims the benefit of U.S. Provisional Application Ser. No. 62/251,861, filed on Nov. 6, 2015, wherein is hereby incorporated by reference herein in its entirety.

### FIELD OF THE INVENTION

The present invention relates generally to HVAC systems and, more particularly, to an inspection system and method for HVAC units.

### BACKGROUND OF THE INVENTION

Dampers and louvers are critical to the operational performance of HVAC systems in buildings and other structures. Such devices maintain building pressurization, prevent the spread of fire or smoke, and/or prevent water penetration during a tropical storm or hurricane.

Many critical devices, such as fire and smoke dampers, require periodic inspection and verification of operation on a specified schedule in order to comply with local, state, federal and/or international building and fire codes. Existing methods of inspection and verification typically require a technician to physically access the interior of the HVAC duct at the device location and to actuate the device in order to observe proper operation. As will be readily appreciated, however, this is often difficult because the device may be inaccessible or difficult to access, especially after building completion.

In view of the above, there is a need for a system and method that facilitates the noninvasive inspection of a damper or louver device within a HVAC system.

### SUMMARY OF THE INVENTION

It is an object of the present invention to provide an inspection system for HVAC units.

It is another object of the present invention to provide an inspection system for HVAC units that provides for local and remote visual inspection and verification of damper operation.

These and other objects are achieved by the present invention.

According to one embodiment of the present invention, an inspection system for an HVAC device, such as a fire and/or smoke damper, is provided. The inspection system includes an HVAC duct section, a damper positioned with the duct section, an actuator for selectively moving the damper to a closed position, and a verification camera for recording the position of the damper with a date stamp and a time stamp. The actuator is further configured to move the damper to its open position, and the verification camera is further configured to record the open position of the damper with a second date and time stamp.

According to another embodiment of the present invention, an inspection method for an HVAC device, such as a fire and/or smoke damper, is provided. The method includes the steps of selectively controlling a damper to a first, closed position, and recording the damper position utilizing a camera with a first date and time stamp. The method also includes selectively controlling the damper to a second, open position, and recording the damper position utilizing the camera with second date and time stamp.

According to yet another embodiment of the present invention, an inspection system for an HVAC device is provided. The inspection system includes a duct section, a damper device positioned within the duct section, an actuator operatively connected to the damper device and being configured to selectively move the damper device between a closed position and an open position, and an image capture device configured to create a visual record of the damper device in the closed position and the open position and providing for remote visual inspection and verification of damper device operation.

### BRIEF DESCRIPTION OF THE DRAWINGS

The present invention will be better understood from reading the following description of non-limiting embodiments, with reference to the attached drawings, wherein below:

FIG. 1 is schematic illustration of an HVAC inspection system according to an embodiment of the present invention.

FIG. 2 is front, cross-sectional, schematic illustration of the HVAC inspection system of FIG. 1.

### DETAILED DESCRIPTION OF THE PREFERRED EMBODIMENT

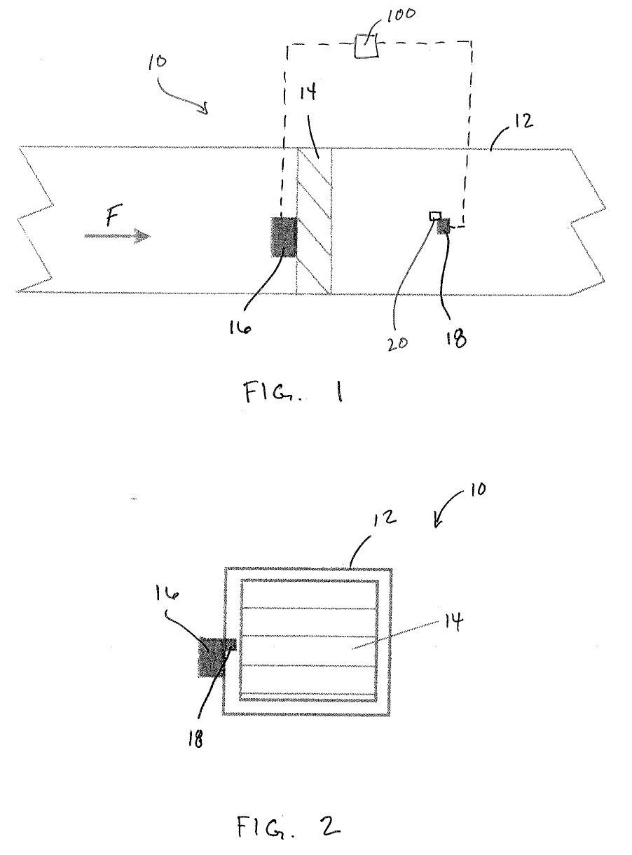

Referring to FIG. 1, the present invention relates to an inspection system for an HVAC device. As illustrated in FIG. 1, an HVAC system 10 typically includes an air transport duct 12 formed from a plurality of interconnected duct sections. The air transport duct 12 is configured to route conditioned air (e.g., heated, cooled and/or purified air) to desired locations within a building or other structure. The air transport duct 12 typically includes therein a series of damper or louver devices that are configured to control the air flow, F, within the duct. As is known in the art, the damper devices may be selectively controlled to a variety of positions within the duct in dependence upon a desired level of heating, cooling or the like. For example, known damper devices may be controlled between a fully closed position, in which the damper device substantially closes off the duct 12 to prevent air from flowing pass the damper device, to a fully open position corresponding to maximum air flow past the damper device.

In addition to standard damper and louver devices for controlling air flow within a duct, local, state, federal and/or international building and fire codes often require the presence of smoke or fire dampers. Fire, smoke and combination fire/smoke dampers are used to protect life and limit property loss during a life safety event. In particular, a fire/smoke damper is used with a building air handling system as a prevention device for the spread of fire and smoke. Fire/smoke dampers, unlike traditional HVAC dampers, typically function either in a fully open or fully closed position and, thus, extreme blade positions must be reachable and are regularly tested. FIG. 1 illustrates an exemplary fire or smoke damper 14 positioned within duct 12.

In connection with the above, HVAC system 10 may include an actuator 16 operatively connected to the damper 14. The actuator 16 is configured to actuate the damper in response to a control signal received from a control unit, for example, control unit 100. As illustrated in FIG. 1, the control unit 100 may be located remotely from the damper 14 and actuator 16, and may be coupled with the actuator 16 via a wireless or wired connection. In an embodiment, the control unit 100 may be a building management system or other centralized controller for controlling the HVAC system, as a whole, in response to a desired setpoint temperature or other input signals.

In addition, the system 10 includes a verification and monitoring device positioned within the duct 12 adjacent to the damper 14. For example, the verification monitoring device may be an image capture device such as a digital camera 18 having an associated light source 20 for recording or capturing a still image of a position of the damper 14, as discussed hereinafter. The image capture device 18 may likewise be in wired or wireless communication with the control unit 100 and receive operational commands therefrom.

In an embodiment, the actuator 16 is a hard-wired switching console that may be selectively actuated, in response to a signal received from the control unit 100, to open and close the damper 14. During a verification or testing mode, the control unit 100 may prompt the actuator 16 to move the damper 14 to its fully closed position. Once the damper 14 is closed, the control unit 100 controls the image capture device 18 to take a snapshot or still image (or otherwise record the position) of the damper 14 with a first date and time stamp that is then stored in a database associated with the control unit 100. After recording the ‘closed’ position of the damper 14 with a date and time stamp, the control unit 100 controls the actuator 16 to move the damper 14 to its normal or default operating state (i.e., the fully open position), and controls the image capture device 18 to record the ‘open’ position of the damper 14 with a second date and time stamp, that is likewise stored in a database.

In an embodiment, recording the position of the damper 14 may include taking a photograph or short video of the position of the damper 14. In an embodiment, the short video is of a duration long enough to capture movement of the damper 14 from the open position, to the closed position, and back to the open position. In yet other embodiments, the image capture device 18 is configured to transmit a live feed of the damper 18 back to the control unit 100 for display to an operator or technician, or for logging in memory or database. In certain embodiments, the image capture device 18 may operate on a time delay such that an image of the damper 14 is captured after a predetermined amount of time has elapsed after the command signal to open or close the damper 14 is communicated to the actuator 16.

In another embodiment, an actuator relay (not shown) may be incorporated into the image capture device 18. Once triggered, such as by the control unit, the relay would then actuate the damper 14 and the image capture device 18 would record the movement and/or position of the damper 14 in the manner described above.

In the preferred embodiment, the electronics for the image capture device 18 are mounted outside the duct section 12, with only a small penetration into the air stream for the camera lens and light source (such as a LED light source). In an embodiment, the image capture device 18 is located entirely outside the duct section 12 and has a line if sight to the damper 14 through a small aperture in a wall of the duct section 12. Importantly, this minimal intrusion into the duct section minimizes the disruption of air flow during system operation. Communications to and from the image capture device 18 and/or actuator 16 may be provided by various means known in the art, such as Power over Ethernet (PoE). In an embodiment, the software for addressing the image capture device 18 and/or actuator 16 and for recording verification results is capable of local or cloud based deployment and is capable of operating from a PC or as a device independent application for cloud based deployment.

Importantly, the system and method of the present invention allows for the noninvasive inspection of HVAC fire and smoke dampers. In particular, in contrast to existing methods, the system of the present invention allows for a visual record of inspection to be obtained without requiring a technician to physically enter the duct in the area of the damper. The inspection may be performed as needed, and as initiated by a technician or operator from a remote location, or may be carried out automatically at preset time intervals (e.g., weekly, monthly, yearly or the like).

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. An inspection system for an HVAC device, comprising:
a duct section;
a damper positioned within the duct section;
an actuator operatively connected to the damper and being configured to selectively move the damper between a closed position and an open position; and
an image capture device for recording a position of the damper with a date and time stamp.

2. The inspection system of claim 1, wherein:
the image capture device is configured to capture a first image of the damper in the closed position with a first date and time stamp; and
the image capture device is configured to capture a second image of the damper in the open position with a second date and time stamp.

3. The inspection system of claim 2, further comprising:
a control unit configured to control the actuator to move the damper between the closed position and the open position, and to control the image capture device to capture the first image and the second image.

4. The inspection system of claim 2, wherein:
the image capture device is located substantially outside the duct section.

5. The inspection system of claim 1, wherein:
the image capture device is configured to record a short video of the damper, including movement of the damper from the open position to the closed position, and back to the open position.

6. The inspection system of claim 1, wherein:
the image capture device is configured to transmit a live feed of the damper for display.

7. The inspection system of claim 2, wherein:
the damper is at least one of a smoke damper and a fire damper.

8. The inspection system of claim 2, wherein:
the image capture device includes a light source for illuminating the damper.

9. The inspection system of claim 1, wherein:
the image capture device is configured to operate on a time delay based on a control signal sent to the actuator.

10. A method for inspecting an HVAC device, comprising the steps of:
controlling a damper device within a duct section to a first position;
creating a first visual record of the damper device in the first position;
controlling the damper device to a second position; and
creating a second visual record of the damper device in the second position.

11. The method according to claim 10, wherein:
the first visual record includes a first date and time stamp of the damper device in the first position; and
the second visual record includes a second date and time stamp of the damper device in the second position.

12. The method according to claim 11, wherein:
in the first position, the damper device substantially closes off the duct section to prevent air from flowing pass the damper device; and
in the second position, the damper device does not close off the duct and permits maximum air flow past the damper device.

13. The method according to claim 12, wherein:
the step of creating the first visual record includes capturing at least one of a still image and a video of the damper device in the first position; and
the step of creating the first visual record includes capturing at least one of a still image and a video of the damper device in the second position.

14. The method according to claim 12, wherein:
creating the first visual record and the second visual record includes transmitting a live feed of the damper device during movement of the damper device from the first position to the second position.

15. The method according to claim 13, wherein:
the at least one of the still image and the video of the damper device in the first position and the second position, respectively, are captured with an image capture device located substantially outside the duct section.

16. The method according to claim 12, further comprising the step of:
storing the first visual record and the second visual record in memory.

17. The method according to claim 12, wherein:
the damper device is a smoke or fire damper.

18. An inspection system for an HVAC device, comprising:
a duct section;
a damper device positioned within the duct section;
an actuator operatively connected to the damper device and being configured to selectively move the damper device between a closed position and an open position; and
an image capture device configured to create a visual record of the damper device in the closed position and the open position and providing for remote visual inspection and verification of damper device operation.

19. The inspection system of claim 18, wherein:
the visual record includes a first date and time stamp corresponding with the closed position and a second date and time stamp corresponding with the open position.

20. The inspection system of claim 19, wherein:
the image capture device is located substantially outside the duct section.
